(19) United States
(12) Patent Application Publication
(10) Pub. No.: US 2011/0141851 A1
(43) Pub. Date: Jun. 16, 2011

(54) SYSTEM AND METHOD FOR INTEGRATED RESERVOIR AND SEAL QUALITY PREDICTION

(75) Inventors: Marek Kacewicz, Sugarland, TX (US); Sankar Kumar Muhuri, Houston, TX (US); Jozina Belinda Dirkzwager, Houston, TX (US); Peter Thomas Connolly, Houston, TX (US); Gavin Jones Lewis, Houston, TX (US)

(73) Assignee: Chevron U.S.A. Inc.

(21) Appl. No.: 12/639,254

(22) Filed: Dec. 16, 2009

(51) Int. Cl. G01V 1/28

(52) U.S. Cl. 367/73

(57) ABSTRACT

A system for and method of integrated reservoir and seal prediction is useful for evaluation of effective mean stresses affecting geologic systems through their history, and subsequently to predict reservoir and seal quality, flow and seal properties and other behaviors. Porosity and permeability as well as seal properties are modeled based on the effective mean stress. Integrated earth models are built using seismic interpretations, wells and other available data. Geo-mechanical earth models are built and stresses are computed. Basin models are built using inputs from seismic interpretation tools, wells, geochemistry, and earth and mechanical earth models. Reservoir quality and seal quality prediction is performed and the building earth models, computing stresses, building basin models and quality prediction are iterated to converge to a solution that honors well, seismic, core, geochemical and any other available calibration data.

### FIELD OF THE INVENTION

The present invention relates generally to modeling of hydrocarbon reservoirs and more particularly to integrating mechanical earth models, earth models and basin models.

### BACKGROUND OF THE INVENTION

Hydrocarbon exploration in deep reservoirs introduces a likelihood that the reservoir is currently or has historically been subjected to high temperatures and pressures, and/or has been subjected to tectonic forces, all of which may result in effects on structure of the reservoir. As a result, an understanding of these effects on reservoir size, fluid properties and producibility becomes valuable. For existing, producing reservoirs, such an understanding can lead to improved strategies for production enhancement.

In general, approaches have been based on vertical stress and temperature histories. Likewise, basin modeling tools generally do not account for non-vertical stresses or changing principal stress orientations over time. Accordingly, the inventors have developed an integrated modeling method that may provide for solutions to these and other issues in reservoir characterization.

### SUMMARY OF THE INVENTION

An aspect of an embodiment of the present invention includes a method for modeling properties in a subsurface region of interest. The method includes using data representative of geological, geophysical, and/or petrophysical attributes in the subsurface region, building an earth model for the subsurface region, building a mechanical earth model for the subsurface region based on at least part of the data, and building a basin model for the subsurface region based on at least part of the data. The basin model and the mechanical earth model are calibrated against data relating to the subsurface region of interest. The earth model, mechanical earth model, and basin model are iteratively evaluated to converge modeled properties with measured attributes in the subsurface region of interest.

### DESCRIPTION OF THE DRAWINGS

Other features described herein will be more readily apparent to those skilled in the art when reading the following detailed description in connection with the accompanying drawings, wherein:

FIG. 1 is an illustration of a method or workflow in accordance with an embodiment of the present invention;

FIG. 2 is an illustration of a method or workflow in accordance with an alternate embodiment of the present invention; and

FIG. 3 is a schematic illustration of an embodiment of a system for performing methods in accordance with embodiments of the present invention.

### DETAILED DESCRIPTION

In accordance with an embodiment of the invention, a method of integrated earth modeling incorporates interdependent models based on data representative of geological, geophysical and/or petrophysical features of the region of interest. The integrated models iteratively interact in order to provide predictions of, for example, reservoir quality and flow and seal properties. By use of integrated models of different types, effective mean stresses within the region of interest may be evaluated through geologic history in three dimensions. Initial observations from selected case studies where integrated reservoir and seal prediction approaches as described below suggest that a good understanding of stress and temperature anomalies associated with for example salt diapirs, salt pillows, salt canopies, mud diapirs, etc.

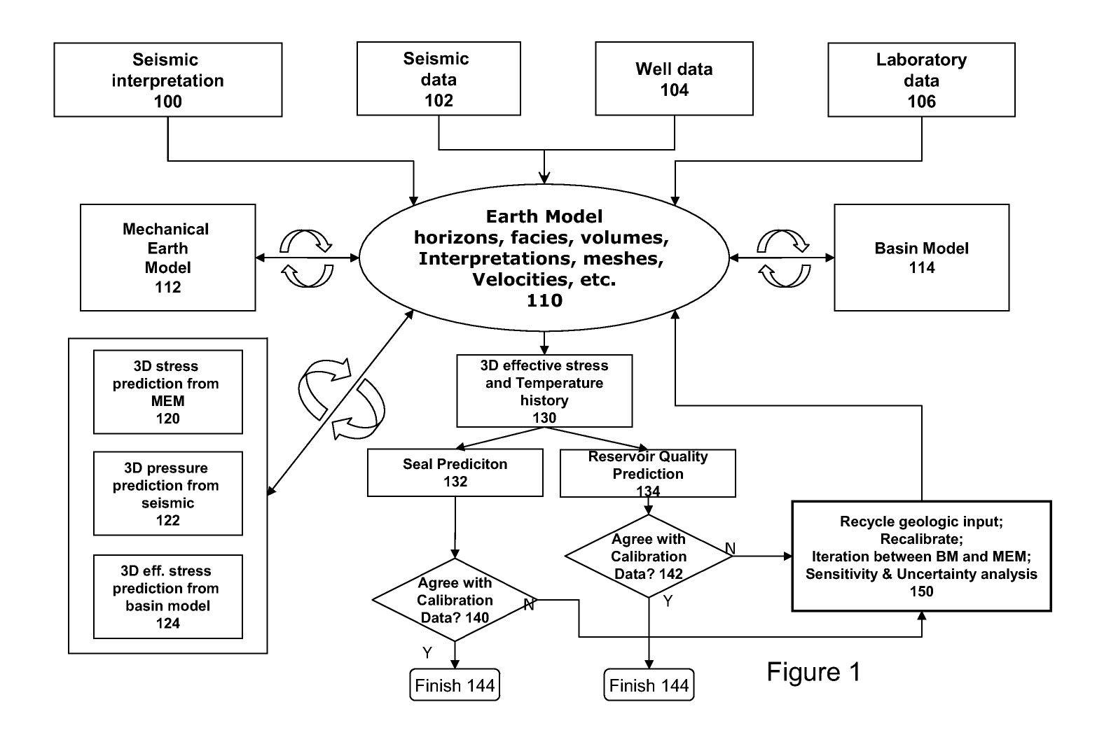

FIG. 1 schematically illustrates an example of an integrated earth model in accordance with an embodiment of the present invention. Data from various sources, including, for example, seismic interpretation 100, seismic data 102, well data 104, and/or laboratory data 106 may be incorporated into the model. Laboratory data may include, for example, laboratory measurements of rock properties from core samples and fluid samples such as wettability, capillary entry pressure, rock composition, sorting, grain size, quartz cement, clay coats, brittleness, or the like. As will be appreciated, other types of data may be incorporated, or some sub-set of the aforementioned data types may be used. In general, data may be from a variety of proprietary sources, and may be stored in a computer readable medium for access and transformation in accordance with the integrated earth model.

Based on the input data, an earth model 110 is built. As will be appreciated, this step may be performed using available or future geological earth modeling applications. For example, GOCAD, available from Paradigm, of George Town, Cayman Islands, is a commonly used earth modeling software suite and would be appropriate for use in accordance with embodiments of the present invention.

Based in part on the earth model, a mechanical earth model 112 (i.e., a numerical representation of the state of stress and rock mechanical properties for a specific stratigraphic section in a field or basin) is built for at least a portion of the subsurface region of interest. The mechanical earth model may be built using available or future tools that are available for this purpose. For example, Abaqus, available from Dassault-Systemes, of Velizy-Villacoublay, France, is a commonly used numerical modeling software. As will be appreciated, mechanical earth models may be selected that allow for computation of stresses using assumptions regarding physical characteristics including, but not limited to, elasticity, placticity and viscosity, may use a range of meshes, and numerical solving tools based on defined initial and boundary conditions. In an embodiment, the mechanical earth model includes stress, strain and/or energy fields within the region of interest.

A basin model 114, is built, using basin modeling tools or suites using inputs from the earth model 110, the data 100, 102, 104, 106 and/or the mechanical earth model 112. For example, Petromod, available from Schlumberger, of Aachen, Germany, is a commonly used basin modeling software. The basin model may be, for example, a four dimensional model that includes evolution of the basin over time.

The mechanical earth model 112 may use pressure predictions and/or vertical stresses derived from the basin model 114 in order to obtain the residual stress fields for the mechanical earth model. Likewise, vertical components of the basin model 114 should be consistent with the mechanical earth model 112. Vertical components of the basin model 114 should further agree with well data 104, where available.

Once constructed, the models are iteratively evaluated, with the goal of converging modeled attributes of the subsurface region towards measured attributes. In particular, using appropriate prediction tools, three dimensional stress predictions 120 may be made based at least in part on the mechanical earth model. Three dimensional pressure predictions 122 may be made based on seismic data 102, where available. And, three dimensional effective stress predictions 124 may be made based on the basin model. These predicted modeled attributes can be compared with the measured data. Where there is disagreement between prediction and measurement, the models 110, 112, 114 are adjusted and new predictions are generated.

Similarly, three dimensional effective stress and temperature history 130 may be generated based on outputs of one or more of the models 110, 112, 114. Based on these predictions, qualitative predictions such as seal predictions 132 and reservoir quality predictions 134 may be generated. These predictions are compared against appropriate calibration data, and the models are adjusted in accordance with any disagreement that is found.

By way of example, seal predictions may be checked 140 against well data such as capillary entry pressure, porosity, permeability, well logs including, for example, neutron, resistivity, density, and/or seismic velocity data and/or permeability data. Likewise, reservoir quality may be checked 142 against porosity, permeability and/or IGV (intergranular volume). To the extent that predictions agree with the calibration data, the model can be considered to be accurate and the iterative process may be halted 144. For larger numbers of wells, and therefore more well data, it may be that more iterations are required for convergence. On the other hand, more well data can also result in better initial models, and therefore more accurate initial predictions.

Using sensitivity and uncertainty analyses the basin model and the mechanical earth model may be adjusted 150 in order to improve the calibration of the integrated earth model. In an embodiment, the basin model is preferentially adjusted more often than is the mechanical earth model. This is in part because typically, mechanical earth models calculate present day stress field which may be easier to calibrate using well and production data. On the other hand, basin models are designed to provide effective stress and temperature through geologic time. While temperature history is generally easier to calibrate, effective stress generally requires more iterations between basin models and reservoir/seal quality prediction tools.

Calibration data for the mechanical earth model may include, for example, pressure, density of rock, fracture, mechanical rock properties and/or combinations thereof. Similarly, calibration data for the basin model may include temperature data, sonic data, pressure data, geochemical data such as vitrinite reflectance, biomarkers, and/or combinations thereof. In certain cases, the calibration data may incorporate all or part of the data used to create the earth model, and may in general comprise a subset of the initial data on which the model is built.

In an embodiment, the predicted values of the geophysical, geological and/or petrophysical attributes are compared to corresponding measured attributes. Where the predicted and measured attribute values are within a selected range of variation, the iterative process may be halted. In this regard, the selected range may be a user-input range, a preselected range, or a quantitatively-determined range.

In an embodiment, each of the models 110, 112, 114 may incorporate one-, two-, and/or three-dimensional models. Furthermore, at least the mechanical earth model 112 and the basin model 114 may incorporate a time dimension.

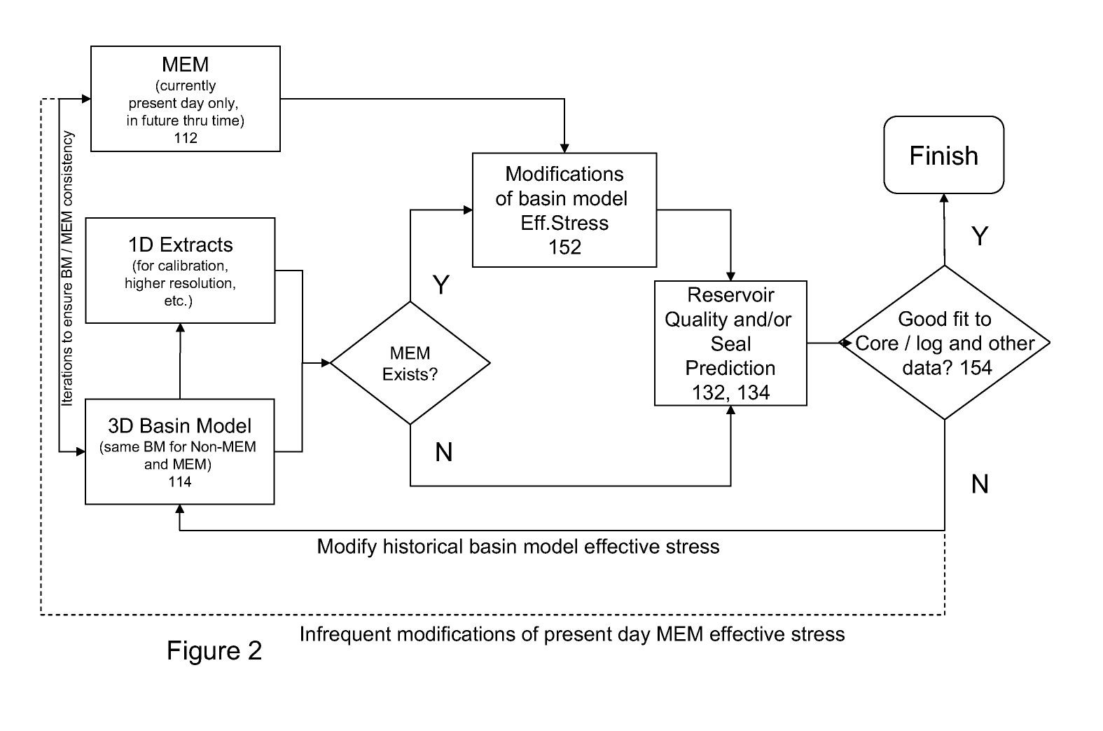

In an embodiment as illustrated in FIG. 2, calculation efficiency may be improved through the use of one-dimensional extractions. In this approach, the mechanical earth model 112 and the basin model 114 are iterated against each other to ensure that they are consistent with each other. In this approach, the mechanical earth model 112 may be a present day only effective stress model, while the basin model 114 incorporates information relating to historical effective stresses. On the other hand, it will be appreciated that the mechanical earth model may incorporate information about effective stress through time.

For the purpose of calibration, one dimensional extracts are taken from the basin model 114. By way of example, such one dimensional extracts may be pseudo-well data derived from the model. In the case where there is a mechanical earth model, it may be used to modify the effective stresses 152 of the basin model prior to evaluating reservoir quality and/or seal predictions 132, 134 as previously described with respect to the embodiment of FIG. 1. If the qualitative predictions are a good fit 154 to the available measured data, then the process is complete. If not, then iterative modifications to the basin model and mechanical earth model may be made. In an embodiment, the basin model is preferentially modified, and the mechanical earth model is less frequently modified. As will be appreciated, the branch of the flowchart in which there is no mechanical earth model relates to embodiments in which only the basin model and earth model are integrated.

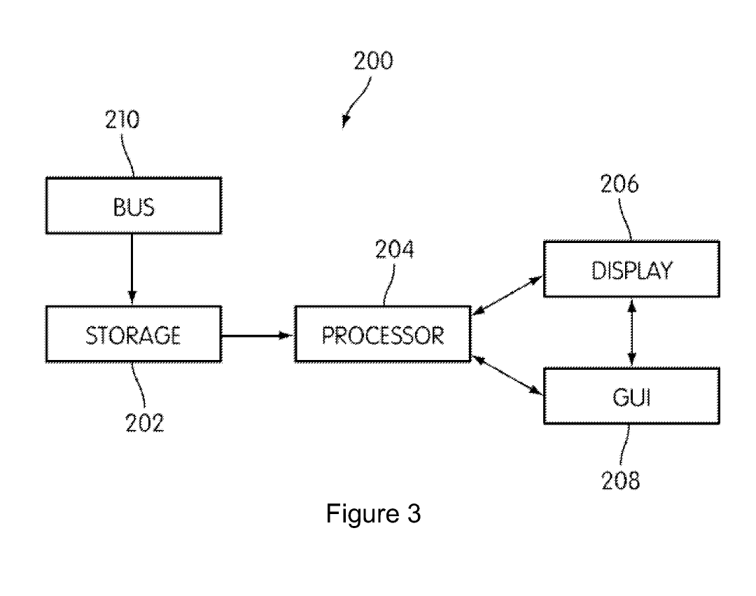

A system for performing the method is schematically illustrated in FIG. 3. A system includes a data storage device or memory 202. The stored data may be made available to a processor 204, such as a programmable general purpose computer. The processor 204 may include interface components such as a display 206 and a graphical user interface 208. The graphical user interface may be used both to display data and processed data products and to allow the user to select among options for implementing aspects of the method. Data may be transferred to the system 200 via a bus 210 either directly from a data acquisition device, or from an intermediate storage or processing facility (not shown).

Those skilled in the art will appreciate that the disclosed embodiments described herein are by way of example only, and that numerous variations will exist. The invention is limited only by the claims, which encompass the embodiments described herein as well as variants apparent to those skilled in the art.

What is claimed is:

1. A method for modeling properties in a subsurface region of interest, comprising:
using data representative of geological, geophysical, and/or petrophysical attributes in the subsurface region, building an earth model for the subsurface region;
building a mechanical earth model for the subsurface region based on at least part of the data;
building a basin model for the subsurface region based on at least part of the data;
calibrating the basin model and the mechanical earth model against data relating to the subsurface region of interest, and
iterating of and between the earth model, mechanical earth model, and basin model to converge modeled properties with measured attributes in the subsurface region of interest.

2. A method as in claim 1, wherein the iterating comprises:
making predictions of a value of a geophysical, geological or petrophysical attribute in the subsurface region of interest;
comparing the predicted value of the attribute with an respective measured attribute in the subsurface region of interest; and
when the predicted and the measured attribute values are within a selected range, ending the iterating.

3. A method as in claim 2, wherein the measured geological, geophysical and/or petrophysical attributes comprise calibration data, and the calibration data comprise a subset of the data used to build the earth model.

4. A method as in claim 1, wherein the data representative of geological, geophysical and/or petrophysical attributes in the subsurface region comprise one or more of seismic data, well log data, seismic interpretation data and laboratory measurements of rock properties

5. A method as in claim 1, wherein a mechanical earth model for the subsurface region comprises an evaluation of stress, strain and energy fields within the subsurface region of interest.

6. A method as in claim 1, wherein a mechanical earth model for the subsurface region comprises evaluation of one or more physical characteristics selected from the group consisting of elasticity, plasticity and viscosity.

7. A method as in claim 1, wherein a mechanical earth model for the subsurface region comprises numerical analysis using varied initial and boundary conditions.

8. A method as in claim 1, wherein a mechanical earth model for the subsurface region includes using attribute, including pressure, predictions from the basin model.

9. A method as in claim 1, wherein the earth model, the basin model and the mechanical earth model comprise three dimensional models.

10. A method as in claim 9, wherein the earth model, the basin model and the mechanical earth model further comprise a time dimension.

11. A method for modeling properties in a subsurface region of interest, comprising:
obtaining data representative of geological, geophysical, and petrophysical attributes in the subsurface region;
building an earth model for the subsurface region, using the data;
building and generating a basin model for the subsurface regions, using the data and the earth model;
building and generating a mechanical earth model for the subsurface, based on the earth model and using predictions including pressure derived from the basin model;
making predictions of one or more values of a geophysical, geological and/or petrophysical attributes based on the earth model, the basin model and the mechanical earth model;
extracting predicted attributes at a pseudo-well location from the basin model;
extracting predicted attributes at a pseudo-well location from the mechanical earth model;
comparing the value for the extracted predicted property with corresponding calibration data, when the value for the predicted property agrees with the corresponding calibration data within a selected range, accepting the models as representative of the region of interest, and when the value for the predicted property does not agree with the corresponding calibration data within the selected range, iterating between the one dimensional extracts from the mechanical earth, and basin models to converge predicted properties with calibration data.

12. A method for modeling properties in a subsurface region of interest, comprising:
obtaining data representative of geological, geophysical, and petrophysical attributes in the subsurface region;
building an earth model for the subsurface region, using the data;
building and generating a basin model for the subsurface regions, using the data and the earth model;
building and generating a mechanical earth model for the subsurface, based on the earth model and using predictions including pressure derived from the basin model;
making predictions of one or more values of geophysical, geological or petrophysical attributes based on the earth model, the basin model and the mechanical earth model; and
comparing the values for the predicted properties with corresponding calibration data, when the values for the predicted property agrees with the corresponding calibration data within a selected range, accepting the models as representative of the region of interest, and when the value for the predicted property does not agree with the corresponding calibration data within the selected range, iterating between the earth, mechanical earth, and basin models to converge predicted properties with calibration data.
